(19) United States
(12) Patent Application Publication
(10) Pub. No.: US 2026/0356363 A1
(43) Pub. Date: Nov. 12, 2026

(54) VEHICLE AND METHOD FOR CONTROLLING SAME

(71) Applicants: HYUNDAI MOTOR COMPANY, Seoul (KR); KIA CORPORATION, Seoul (KR)

(72) Inventors: Jung Woo HAN, Hwaseong-si (KR); Su Jung YOO, Hwaseong-si (KR); Jin Kwon KIM, Hwaseong-si (KR)

(21) Appl. No.: 19/640,113

(22) Filed: Apr. 6, 2026

(30) Foreign Application Priority Data
May 7, 2025 (KR) 10-2025-0059128

(51) Int. Cl. B60W 30/165; B60W 60/00

(52) U.S. Cl. CPC B60W 30/165; B60W 60/00184; B60W 2552/53

(57) ABSTRACT

Disclosed are an autonomous vehicle control device and a control method thereof. An apparatus for an autonomous vehicle may include a processor and a memory storing at least one instruction. The at least one instruction may be configured to be executed by the processor to cause the apparatus to: determine whether at least one road segment, in which a lane marking is missing for at least a threshold distance, is detected in a planned travel route of the autonomous vehicle; set, based on whether historical traffic lane information includes lane information of the at least one road segment, a region of interest; select a lead vehicle that satisfies a predetermined condition; set the monitored path of the lead vehicle as a reference path of the autonomous vehicle; and control, based on the reference path, an autonomous driving operation of the autonomous vehicle.

### CROSS-REFERENCE TO RELATED APPLICATION

This application claims priority to and the benefit of Korean Patent Application No. 10-2025-0059128, filed May 7, 2025 in the Korean Intellectual Property Office, the disclosure of which is incorporated herein by reference in its entirety.

### FIELD OF TECHNOLOGY

The present disclosure relates to an autonomous vehicle and a method of controlling an autonomous vehicle.

### BACKGROUND

An autonomous vehicle requires a technology for generating and controlling a stable travel path by recognizing a lane, a lead vehicle, and the like. In particular, in an environment where a lane making or other road surface markings are temporarily discontinued, such as at an intersection or a curved section of the road, a problem may arise whereby a criterion for the vehicle to determine a travel path can become unclear.

Some implementations of autonomous vehicle may, for example, rely on a lane-centered path generation method, but this method has a limitation in that control reliability is relatively low in a lane loss situation, and thus it may be difficult to generate a path following an object having an unstructured trajectory, such as a lead vehicle that is turning at an intersection.

The matters described in this Background section are only for enhancement of understanding of the background of the disclosure, and should not be taken as acknowledgement that they correspond to prior art already known to those skilled in the art.

### SUMMARY

The technical object to be achieved by the present disclosure has been devised in order to solve the above-described problems, and an object of the present disclosure is to provide a technology for maintaining following control of an autonomous vehicle in a section in which a lane loss section is generated.

The problems to be solved by the present disclosure are not limited to the above-mentioned problems, and other problems that are not mentioned will be clearly understood by a person skilled in the art from the following description.

According to one or more example embodiments of the present disclosure, an apparatus for an autonomous vehicle may include a processor and a memory storing at least one instruction. The at least one instruction may be configured to be executed by the processor to cause the apparatus to: determine whether at least one road segment, in which a lane marking is missing for at least a threshold distance, is detected in a planned travel route of the autonomous vehicle; set, based on detecting the at least one road segment and based on whether historical traffic lane information includes lane information of the at least one road segment, a region of interest; select, among one or more objects recognized in the region of interest, a lead vehicle that satisfies a predetermined condition; based on a monitored path of the lead vehicle matching the planned travel route of the autonomous vehicle, set the monitored path of the lead vehicle as a reference path of the autonomous vehicle; and control, based on the reference path, an autonomous driving operation of the autonomous vehicle.

The at least one instruction may be configured to be executed by the processor to cause the apparatus to set the region of interest by: based on the historical traffic lane information not including the lane information of the at least one road segment, setting the region of interest based on a position of the autonomous vehicle and a heading of the autonomous vehicle.

The lead vehicle may be a vehicle closest to the autonomous vehicle, among vehicles recognized in the region of interest, and is traveling in a same direction as the autonomous vehicle.

The predetermined condition may include the monitored path of the lead vehicle being greater than or equal to a predetermined distance.

The predetermined condition may include a heading of the lead vehicle being within a predetermined angle with reference to a heading of the autonomous vehicle.

The predetermined condition may include a lateral position of the lead vehicle being within a predetermined distance from the reference path.

The at least one instruction may be configured to be executed by the processor to further cause the apparatus to: based on the lead vehicle deviating from the reference path by at least a predetermined distance for at least a predetermined time duration, select a new lead vehicle to follow.

The at least one instruction may be configured to be executed by the processor to further cause the apparatus to: control the autonomous vehicle to continue to follow the lead vehicle based on an updated monitored path of the lead vehicle matching the planned travel route of the autonomous vehicle.

The at least one instruction may be configured to be executed by the processor to further cause the apparatus to: output, via a user interface of the autonomous vehicle, an indication of at least one of: the region of interest, the lead vehicle, or the reference path.

According to one or more example embodiments of the present disclosure, a method performed by an apparatus of an autonomous vehicle may include: determining whether at least one road segment, in which a lane marking is missing for at least a threshold distance, is detected in a planned travel route of the autonomous vehicle; setting, based on detecting the at least one road segment and based on whether historical traffic lane information includes lane information of the at least one road segment, a region of interest; selecting, among one or more objects recognized in the region of interest, a lead vehicle that satisfies a predetermined condition; based on a monitored path of the lead vehicle matching the planned travel route of the autonomous vehicle, setting the monitored path of the lead vehicle as a reference path of the autonomous vehicle; and controlling, based on the reference path, an autonomous driving operation of the autonomous vehicle.

Setting the region of interest may include: based on the historical traffic lane information not including the lane information of the at least one road segment, setting the region of interest based on a position of the autonomous vehicle and a heading of the autonomous vehicle.

The lead vehicle may be a vehicle closest to the autonomous vehicle, among vehicles recognized in the region of interest, and is traveling in a same direction as the autonomous vehicle.

The predetermined condition may include the monitored path of the lead vehicle being greater than or equal to a predetermined distance.

The predetermined condition may include a heading of the lead vehicle being within a predetermined angle with reference to a heading of the autonomous vehicle.

The predetermined condition may include a lateral position of the lead vehicle being within a predetermined distance from the reference path.

The method may further include: based on the lead vehicle deviating from the reference path by at least a predetermined distance for at least a predetermined time duration, selecting a new lead vehicle to follow.

The method may further include: controlling the autonomous vehicle to continue to follow the lead vehicle based on an updated monitored path of the lead vehicle matching the planned travel route of the autonomous vehicle.

The method may further include: outputting, via a user interface of the autonomous vehicle, an indication of at least one of: the region of interest, the lead vehicle, or the reference path.

According to one or more example embodiments of the present disclosure, an autonomous vehicle may include: at least one sensor; a processor; and a memory storing at least one instruction. The at least one instruction may be configured to be executed by the processor to cause the autonomous vehicle to: during a driving operation of the autonomous vehicle, generate, via the at least one sensor, an image of an unmarked road segment; monitor a driving path of at least one target vehicle in the unmarked road segment; generate, based on the monitored driving path of the at least one target vehicle matching a planned travel route of the autonomous vehicle, a reference path; and output, based on the reference path, a signal for a driving operation of the autonomous vehicle. A lane marking may be missing in the image of the unmarked road segment.

The at least one target vehicle may include a lead vehicle and at least one candidate lead vehicle. The at least one instruction may be configured to be executed by the processor to further cause the autonomous vehicle to: determine, based on the monitored driving path of the at least one target vehicle, the reference path for the autonomous vehicle to drive along during an autonomous driving operation of the autonomous vehicle; select, based on the lead vehicle deviating from the reference path by at least a threshold distance, a new lead vehicle among the at least one candidate lead vehicle; and continue, based on the monitored driving path of the new lead vehicle matching the planned travel route of the autonomous vehicle, the autonomous driving operation of the autonomous vehicle by following the new lead vehicle.

### BRIEF DESCRIPTION OF THE DRAWINGS

FIG. 1 shows a block diagram of example components of an example autonomous vehicle.

FIG. 2 shows a flowchart illustrating an example method of determining a lead vehicle and generating a reference path.

FIG. 3 shows a flowchart illustrating an example method of determining a region of interest.

FIGS. 4 and 5 show example diagrams illustrating the setting of the region of interest.

FIG. 6 shows a flowchart illustrating an example method of generating a reference path.

FIGS. 7, 8, and 9 show example diagrams illustrating a lead vehicle that has cut out.

FIGS. 9 and 10 show example diagrams comparing a cumulative travel path of a lead vehicle with a reference path of an autonomous vehicle.

FIG. 11 shows an example computing system.

### DETAILED DESCRIPTION

Hereinafter, one or more example embodiments of the present disclosure will be described in detail with reference to the accompanying drawings.

However, the technical idea of the present disclosure is not limited to the particular example embodiment(s) described, but may be implemented in many different forms. Within the scope of the technical idea of the present disclosure, one or more components may be selectively combined or substituted between the example embodiment(s).

In addition, terms used in the example embodiment(s) of the present disclosure (including technical and scientific terms), unless explicitly defined and described otherwise, may be interpreted as having a meaning generally understood by one of ordinary skill in the art to which this disclosure pertains. Commonly used terms, such as those defined in dictionaries, should be interpreted in consideration of the contextual meaning of the related art.

Furthermore, the terms used in the example embodiment(s) of the present disclosure are for the purpose of describing those example embodiment(s) and are not intended to limit the present disclosure.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

In addition, in describing the components of the example embodiment(s) of the present disclosure, terms such as first, second, A, B, (a), (b), etc., may be used.

These terms are only for distinguishing one component from another, and the essence, order, or sequence of the corresponding component is not limited by these terms.

And, when a component is described as being 'connected', 'coupled', or 'joined' to another component, it may include not only cases where the component is directly connected, coupled, or joined to the other component, but also cases where it is 'connected', 'coupled', or 'joined' through another component existing between the component and the other component.

Furthermore, when described as being formed or placed "on" or "under" each component, "on" or "under" may include not only cases where the two components are in direct contact but also cases where one or more other components are formed or placed between the two components. In addition, when expressed as "on" or "under," it may include the meaning of not only an upward direction but also a downward direction with respect to one component.

In the various flowcharts of this document, at least some of the steps may be omitted or their mutual order may be changed, and at least some of the example embodiment(s) of this document may be performed at a specific point in time of each step of the flowcharts. The operations of the various flowcharts in this document may be performed by at least one of the control device 100, the processor 130, and the autonomous vehicle 10. In addition, redundant content in the drawings of this document may be omitted. In this document, the 'control device 100' may also be referred to as the 'autonomous vehicle control device 100'.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., selecting a lead vehicle in a road section where lane markings are not recognizable) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., selecting a lead vehicle in a road section where lane markings are not recognizable) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., selecting a lead vehicle in a road section where lane markings are not recognizable) described herein.

Minimum risk maneuver (MRM) operation(s) may also be controlled, for example, based on one or more features (e.g., selecting a lead vehicle in a road section where lane markings are not recognizable) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., selecting a lead vehicle in a road section where lane markings are not recognizable) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., selecting a lead vehicle in a road section where lane markings are not recognizable) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., selecting a lead vehicle in a road section where lane markings are not recognizable) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., selecting a lead vehicle in a road section where lane markings are not recognizable) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein. For example, an operation control for autonomous driving (e.g., an autonomous driving operation) of the vehicle may include (autonomously) following a lead vehicle, maintaining a distance between the lead vehicle and the ego vehicle, etc.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, a forward vehicle, a front vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

The term “driver control assistance system” as used herein may refer to hardware and software that can assist a driver in continuously controlling the longitudinal and lateral movements of a vehicle. This driver control assistance system may be referred to as an 'autonomous driving system' or 'system' in this document.

The term “feature” as used herein may refer to a specific function of a system that provides assistance to the driver in defined traffic scenarios, situations, and system boundaries.

The term “dynamic control” as used herein may refer to performing the operational and tactical functions necessary to move the vehicle in real time. This may include control of the vehicle's lateral and longitudinal movements, monitoring of the road environment, responding to events in the road traffic environment, operational planning, and signaling.

The “system boundaries” as used herein may refer to verifiable or measurable limits or conditions set by the manufacturer, up to or within the range of conditions that affect the system or the system's functions designed to assist the driver and the system's ability to operate as intended.

In the present disclosure, a “lane unrecognized section” may refer to a section (e.g., a road section or segment) where pavement markings (especially lane line markings) are missing (e.g., lost, nonexistent, discontinued, faded, erased, defaced, etc.) due to, for example, an intersection, ending or merging of traffic lanes, etc., and thus not recognized (e.g., unrecognizable) by the vehicle, and may also be referred to as “unmarked road segment,” “unmarked pavement section,” “lane marking discontinuation road segment,” “lane loss section,” “lane recognition failure section,” etc.

Each step of the flowcharts mentioned in this document may be described as being performed by the processor 130 of the autonomous vehicle 10, but is not limited thereto, and the control device 100 or the autonomous vehicle 10 itself may perform each step.

Hereinafter, one or more example embodiments will be described in detail with reference to the accompanying drawings, but the same or corresponding components will be given the same reference numbers regardless of the drawing numbers, and redundant descriptions thereof will be omitted.

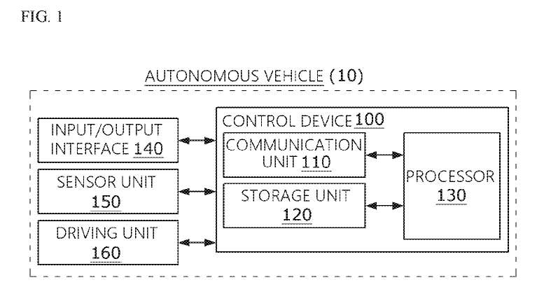

FIG. 1 shows a block diagram of example components of an autonomous vehicle 10.

The autonomous vehicle 10 may include a control device 100, a communication unit (also referred to as communication interface) 110, a storage unit (also referred to as storage, data storage, storage device, memory, etc.) 120, a processor 130, an input/output interface (also referred to as input and output interface, human interface device, user interface, etc.) 140, a sensor unit (also referred to as sensor, sensor array, etc.) 150, and a driving unit (also referred to as powertrain system, drivetrain system, propulsion system, etc.) 160. Each of these components in FIG. 1 may be implemented inside the vehicle.

The autonomous vehicle 10 may be dynamically controlled in various driving situations through an autonomous driving system. For example, the autonomous driving system may provide both driving stability and convenience through longitudinal control (acceleration and deceleration) and lateral control (lane keeping and changing) of the autonomous vehicle 10. This autonomous driving system may monitor the driving environment through sensors and control devices, and process data in real time to adjust the vehicle's position, driving speed, direction, and the like.

The control device 100 may be formed integrally with the internal components of the vehicle, or may be implemented as a separate, independent device from other components inside the autonomous vehicle 10 and communicate with the internal components of the vehicle through various connection means (e.g., CAN bus, wireless network, wired connection, etc.). The control device 100 may include the communication unit 110, the storage unit 120, and the processor 130 to manage the longitudinal and lateral control of the vehicle, and may additionally include other components such as the input/output interface 140, the sensor unit 150, and the driving unit 160 to perform complex control functions according to the driving situation.

The control device 100 may store data collected from the sensor unit 150 during driving in the storage unit 120 and process it in real time to control the safety and convenience functions of the vehicle. For example, the control device may perform overall control and management of the autonomous driving system, such as providing notifications in situations requiring driver intervention based on data detected from the sensor unit 150.

The control device 100 may display the vehicle control status or receive driver input to control driving functions through a user interface linked with an HMI (Human-Machine Interface) based on various driver settings and driving conditions.

The control device 100 may perform functions of determining whether there is a lane unrecognized section (e.g., unmarked road segment), searching for and selecting a lead vehicle, determining whether the cumulative travel path of the corresponding lead vehicle matches the navigation path, and generating a reference path to control driving.

The communication unit 110 may communicate with other control devices inside the vehicle to share data between systems, or transmit and receive various information through connection with the outside of the vehicle. The communication unit 110 may transmit control signals and data between internal components using various in-vehicle communication methods such as CAN communication and Ethernet, and may link driving information and external data in real time through communication with user terminals, other vehicles (V2V: Vehicle-to-Vehicle), infrastructure (V2I: Vehicle-to-Infrastructure), or external servers.

The communication unit 110 may perform short-range communication, GNSS (Global Navigation Satellite System) module (e.g., GPS module), V2X (Vehicle-to-Everything) communication, optical communication, broadcast transmission/reception, and ITS (Intelligent Transport Systems) communication functions. For example, the communication unit 110 may support stable data transmission at close range using various wireless communication technologies such as Bluetooth, RFID (Radio Frequency Identification), IrDA (Infrared Data Association), UWB (Ultra Wideband), ZigBee, NFC (Near Field Communication), Wi-Fi, Wi-Fi Direct, and Wireless USB. In addition, it may perform long-distance communication through mobile communication modules based on mobile communication networks such as LTE and 5G and wireless internet modules to receive real-time data or link with the cloud, thereby improving the performance of the autonomous driving system.

The communication unit 110 may receive the driving history information of a lead vehicle, road infrastructure information, real-time traffic situation, and the like from other vehicles or servers.

The storage unit 120 may include various types of memory capable of storing data, and may be integrated within the control device 100 or the processor 130, or configured as a separate module. The storage unit 120 may include non-volatile memory (e.g., hard disk drive, flash memory, etc.) and volatile memory and may combine them to implement a memory system with various capacities and performances.

The storage unit 120 may include a memory capable of storing and managing various data related to the autonomous driving system.

The storage unit 120 may store the cumulative travel path of a lead vehicle. In addition, the storage unit 120 may store the past travel lane information of the autonomous vehicle, the vehicle position and heading value used for setting (e.g., determining, selecting, etc.) the region of interest, the cut-out determination history of the lead vehicle, navigation path information, and the reference path generation result.

The storage unit 120 may provide a memory including at least one instruction, and the instruction, when executed by the processor 130, may be used to perform control functions such as lane loss section (e.g., unmarked road segment) determination, region of interest setting, lead vehicle selection, cut-out determination, reference path generation, and driving control.

The processor 130 may communicate with various internal components of the autonomous vehicle 10, including the communication unit 110, the storage unit 120, the input/output interface 140, the sensor unit 150, and the driving unit 160, through electrical or operational connections, and control the operation of each component and perform data processing. The processor 130, as a central processing unit for executing instructions and calculating data, may collect, process, and analyze data in real time according to the vehicle's driving environment to perform vehicle control.

The processor 130 may be implemented in the form of hardware, software, or a combination thereof, and may perform vehicle control logic in the form of, for example, a microcontroller, FPGA, or ASIC. In addition, it may include a multi-processor configuration to control complex autonomous driving and driver assistance systems. This processor configuration may support comprehensive vehicle control and stable performance through the execution of autonomous driving and assistance systems, sensor data processing, communication data management, and driving-related determination functions.

The processor 130 may process lane recognition information and object recognition information, select a lead vehicle that satisfies the conditions, and execute a reference path generation command according to whether there is a cut-out and whether the paths match.

The input/output interface 140 serves to receive input related to vehicle control from the user and to transmit the control status of the vehicle and system operation information to the user.

The input/output interface 140 may perform the function of receiving various inputs from the user and transmitting the vehicle control status to the user. For example, the input/output interface 140 may include at least one of input through physical buttons provided inside the autonomous vehicle 10, input through soft buttons displayed on the display of the autonomous vehicle 10, user's voice input, and user's gesture input.

The input/output interface 140 may output the region of interest setting result, the reference path, the lead vehicle information, and the like to the user or system in various forms. The output form may include at least one of visual, auditory, and tactile methods, and may include, for example, graphic output through a display, voice guidance through an audio module, or haptic signals.

The input means may include physical buttons, soft keys on a touch display, a voice recognition function, a gesture recognition function, and the like, through which the user can input commands such as autonomous driving system activation requests, function switching, or driving assistance settings.

In addition, the input means may receive user input through an input device provided on the steering wheel of the autonomous vehicle 10. For example, through buttons mounted on the steering wheel, the driver can input a command to activate or deactivate the autonomous driving system even while driving. This steering wheel-based input can support the user to quickly control autonomous driving functions by providing an intuitive interface.

The output means may include a display, an audio module (e.g., a speaker), a haptic module, and the like, and may provide the user with the status of the autonomous driving system, control transition request notifications, function activation status, and the like in visual, auditory, and tactile forms.

In addition, the status of the autonomous driving system can be intuitively checked through a head-up display (HUD), a cluster, an AVN (Audio Video Navigation), and displays built into the rear-view mirror or side mirrors. In addition, the status of the autonomous driving system can be checked through the display of the console installed in each row of the autonomous vehicle 10, an application on a user terminal, and the like.

The finally generated optimal path may be output through the input/output interface 140.

The sensor unit 150 may include a number of sensors that support the stable operation of the autonomous driving system by detecting various driving and environmental information in real time. The sensor unit 150 may measure the distance and speed to surrounding objects through long-range detection sensors such as RADAR (Radio Detection and Ranging) and LIDAR (Light Detection and Ranging), and may include an ultrasonic sensor to detect objects near the autonomous vehicle 10.

In addition, the sensor unit 150 may include a position sensor such as GPS to collect the position information of the autonomous vehicle 10, and an optical sensor to provide ambient illuminance information so that the system can respond to changes in light. Furthermore, the sensor unit 150 may include an accelerator pedal and a brake pedal sensor, a steering wheel detection sensor, a seating sensor, and the like to monitor the driving control status and user behavior of the autonomous vehicle 10.

The sensor unit 150 may include a camera. The camera may be classified into an external camera and an internal camera. The external camera recognizes the road and the surrounding environment, and the internal camera can comprehensively grasp the situation inside and outside the vehicle by detecting the driver's state (e.g., eye tracking, drowsiness detection) or the indoor situation.

The sensor unit 150 may include a heart rate sensor, a pressure sensor, an infrared sensor, and the like to collect the driver's biometric information or various environmental data.

The sensor unit 150 may collect lane recognition information and object recognition information. For example, the sensor unit 150 may recognize lane markings on the road on an image basis through a camera mounted on the front of the vehicle, and extract the curvature, position, width, loss status, etc., of the lane through an image processing algorithm.

In addition, the sensor unit 150 may detect the distance, relative speed, size, direction, etc., of objects located in front of and around the vehicle through a lidar or radar sensor, and may construct object recognition information including the object's position coordinates, heading value, speed, etc., through the detected information.

The driving unit 160 may include various components that provide the driving force necessary for the driving of the autonomous vehicle 10 and control the operation of the vehicle according to the command output from the control device 100. The driving unit 160 may be composed of devices that generate and transmit the power of the vehicle, such as an engine, a motor, a transmission, a wheel drive system, and a controller that controls them, and through these components, the acceleration, deceleration, and direction change of the autonomous vehicle 10 can be performed.

The driving unit 160 may be controlled to maintain driving safety by performing longitudinal control (e.g., acceleration and deceleration) and lateral control (e.g., lane keeping and changing) of the vehicle. For example, it allows the vehicle to follow a driving path by adjusting the output of the motor or adjusting the rotation speed and direction of the wheels in response to a command from the control device 100.

In addition, the driving unit 160 may include a brake system to reduce the speed of the vehicle or stop it during driving. The driving unit 160 may control the autonomous vehicle 10 based on the engine output in the case of an internal combustion engine vehicle, and through control via an electric motor in the case of an electric vehicle.

The driving unit 160 may control the driving of the autonomous vehicle 10 along the generated reference path and the driving boundary.

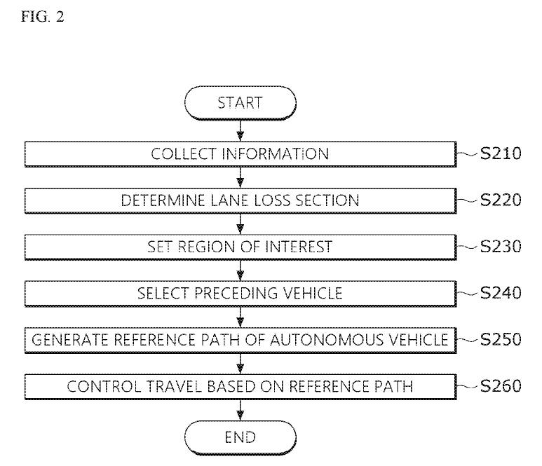

FIG. 2 shows a flowchart illustrating an example method of determining a lead vehicle and generating a reference path.

The control device 100 may collect information necessary to understand the driving environment and the current state of the autonomous vehicle 10 (S210).

The control device 100 may receive lane recognition information and object recognition information from the communication unit 110 or the sensor unit 150.

The lane recognition information may be configured by recognizing a lane marking (e.g., lane line marking) on a road through a camera sensor into a form that includes the position, curvature, loss of a lane (e.g., lane line marking discontinuation), and the like through image processing.

The object recognition information may include information such as distance, relative speed, size, and direction of objects such as other vehicles, pedestrians, structures, and the like positioned in front of or around the autonomous vehicle 10 obtained through a lidar sensor or a radar sensor.

The control device 100 may also collect the global path information received through the communication unit 110. The global path information may include a planned path on which the autonomous vehicle 10 should travel on a coordinate or event basis.

In addition, the past travel history, the lane recognition record, and the cumulative path information of the lead vehicle stored in the storage unit 120 may also be referred to by the control device 100.

The control device 100 may determine whether a section in which the autonomous vehicle 10 is scheduled to travel (e.g., a scheduled or planned travel route of the autonomous vehicle 10) corresponds to a lane loss section, based on the collected lane recognition information (S220).

The lane loss section (also referred to as unmarked road segment) may be defined as a section (e.g., segment) of a road where one or more lanes (e.g., traffic lanes) are not recognized (e.g., unrecognizable by an autonomous vehicle) for at least a predetermined distance in the traveling direction of the vehicle, or where the length (or proportion) of the recognized (e.g., recognized by an autonomous vehicle) lane is less than or equal to a predetermined threshold value (e.g., a lane marking is missing for at least a threshold distance).

To this end, the control device 100 may confirm the presence of left and right lanes included in the lane recognition information and the length of each lane. As the lane loss determination condition, for example, a case where both left and right lanes are not recognized, a case where the length of the recognized lane is less than or equal to a preset length, or the like may be applied. In this case, the control device 100 may set a lane loss determination threshold value for ensuring the traveling stability in consideration of the speed information of the current vehicle.

The control device 100 may set (e.g., determine, select, etc.) a region of interest according to the presence of a lane loss section and the presence of past travel lane information (S230).

When a lane loss section is detected, the control device 100 may determine whether past travel lane information is present in the storage unit 120. When the past travel lane information is present, the control device 100 may set a region of interest based on the information. In this case, the control device 100 may confirm the lane shape and direction with reference to the past travel history of the autonomous vehicle 10 and set a specific range of space as a region of interest accordingly.

When past driving lane information is not present, the control device 100 may set a region of interest based on the current position and the heading value of the autonomous vehicle 10. For example, the control device 100 may set a front region having a predetermined distance and a predetermined (e.g., threshold) width in a straight line forward from the host vehicle. This approach may be utilized to infer a travel space based on the direction of travel even in the absence of lane information.

In addition, when a lane loss section is not detected, the control device 100 may set a region of interest based on the lane recognition information of the autonomous vehicle 10. For example, the control device 100 may define a space including a lane in which the autonomous vehicle 10 is currently positioned as a region of interest based on the lane recognition information.

The control device 100 may select a lead vehicle based on the object recognition information included in the set region of interest (S240).

The control device 100 may extract objects positioned in the region of interest from the object recognition information received from the sensor unit 150 and determine whether there is an object satisfying a preset condition among them.

The control device 100 may preferentially determine a closest object from among the objects in the region of interest based on the traveling direction of the autonomous vehicle 10. For example, the control device 100 may preferentially determine the closest object on the straight-line distance from among the objects in the region of interest with reference to the traveling direction of the autonomous vehicle 10.

In addition, it may be regarded as a valid candidate only when the cumulative travel path of each object has been maintained for a certain distance or more. For example, only an object in which a cumulative travel path stored in the storage unit 120 is 5 m or more may be determined as a lead vehicle candidate.

In addition, the control device 100 may determine that the condition is satisfied only when the heading value of each object is within a predetermined (e.g., threshold) angle with the heading value of the autonomous vehicle 10.

In addition, it can be regarded as a valid lead vehicle only when the lateral position of the object is within a predetermined (e.g., threshold) distance from the reference path or the vehicle centerline.

When an object that satisfies all of these conditions is present, the control device 100 may finally select the object as the lead vehicle.

The control device 100 may generate a reference path of the autonomous vehicle 10 based on the cumulative travel path of the selected preceding vehicle (e.g., lead vehicle) (S250).

The control device 100 may refer to the cumulative travel path of the lead vehicle stored in the storage unit 120 and retrieve time-series coordinate data of the corresponding path to be used as a reference path. The cumulative travel path is a path on which the lead vehicle has actually traveled for a certain period of time and may include position, direction, speed information, and the like at each time point.

The control device 100 may generate a reference path that the autonomous vehicle 10 should follow based on this path data. In addition, when the control device 100 generates the reference path, the control device 100 may perform path interpolation or coordinate correction operation so as to be able to follow the cumulative travel trajectory of the lead vehicle.

The control device 100 may compare the navigation information to determine whether the cumulative travel path of the lead vehicle matches the global path of the autonomous vehicle 10 and then generate a reference path only for the matching section.

The reference path may be used as a travel path of the autonomous vehicle 10 in a later step and may serve as a reference for travel boundary generation, travel control, or collision avoidance determination.

The control device 100 may control the travel of the autonomous vehicle 10 along the generated reference path (S260).

The control device 100 may control operations such as steering, acceleration/deceleration, lane keeping, and the like of the autonomous vehicle 10 based on the position and direction information on the reference path.

The control device 100 may output a control instruction to the driving unit 160 to cause the vehicle to travel from the current position to a target position with reference to the reference path. The driving unit 160 may adjust the speed and the steering angle of the vehicle according to the control instruction and correct the deviation from the reference path according to the real-time travel state.

In addition, the control device 100 may dynamically form a travel boundary so that a collision with an obstacle around the vehicle or an adjacent vehicle does not occur by reflecting the object recognition information and the lane recognition information collected from the sensor unit 150 in real time. Such a travel boundary is set around a reference path and may be defined as a space having no risk of collision within a certain range. The control device 100 may control the steering and speed so that the autonomous vehicle 10 travels only within this travel boundary.

On the other hand, the input/output interface 140 may output the reference path or the traveling state information to the user or the system, and the output information may include a notification of a path change, a following state, and the like according to a determination result during traveling.

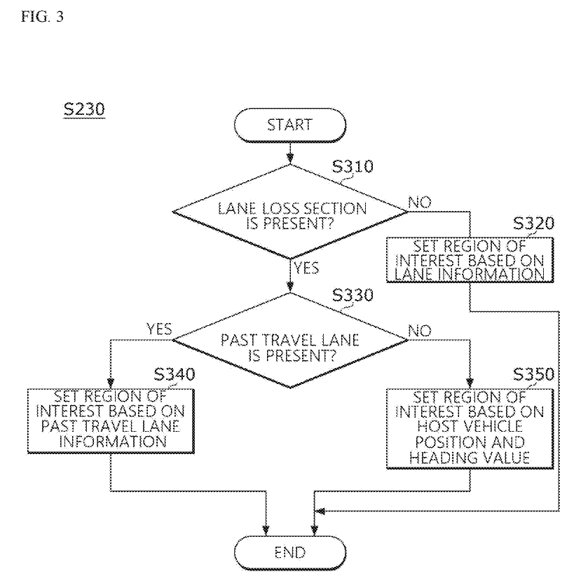

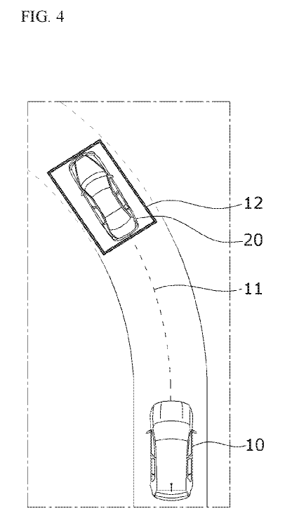

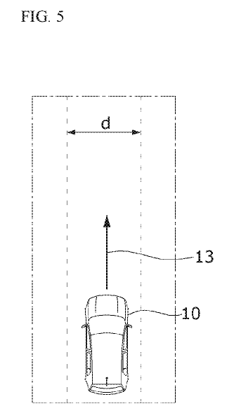

FIG. 3 shows a flowchart illustrating an example method of determining a region of interest. FIG. 3 will be described with reference to FIGS. 4 and 5. FIGS. 4 and 5 are example diagrams illustrating the setting of the region of interest. Contents of FIG. 3 that overlap with those of FIG. 2 will be omitted or briefly described.

The control device 100 may determine whether there is a lane loss section in a section in which the autonomous vehicle 10 is traveling (e.g., a scheduled travel route of the autonomous vehicle 10) (S310).

To this end, the control device 100 may confirm the presence of the left and right lanes and a recognizable length based on the lane recognition information received from the sensor unit 150.

When a lane loss section is not present (S310: NO), the control device 100 may set the region of interest based on the lane information of the section in which the autonomous vehicle 10 is currently traveling (e.g., a travel route of the autonomous vehicle 10) (S320).

In contrast, when a lane loss section is present (S310: YES), the control device 100 may determine the present of past traveling lane information through the storage unit 120 or the communication unit 110 (S330).

The past travel lane information (also referred to as travel history information or data, historical traffic lane information or data, historical travel lane information or data, etc.) may be the history of the autonomous vehicle 10 itself traveling in the same section stored in the storage unit 120 and may also be preceding travel information (e.g., travel history) received by the control device 100 from an external server, traffic infrastructure, or another vehicle through the communication unit 110.

When the control device 100 includes such past travel lane information, the control device 100 may set the region of interest based on the information (S340).

For example, the control device 100 may confirm the curvature of the road, the lane position, the lane width, and the like according to the past travel history, and thereby set a region within a certain range according to the traveling direction of the current autonomous vehicle 10 as the region of interest.

This method enables search of a lead vehicle by setting a spatial reference through the previously accumulated travel data, even in a situation where real-time lane recognition through the sensor unit 150 is difficult or impossible. For example, in an environment such as a curved section before entering an intersection or a section where a road lane is erased, the past travel lane information may be a main criterion for determination.

FIG. 4 shows a diagram illustrating an example of such a situation. As shown in FIG. 4, in a situation in which the autonomous vehicle 10 passes through the left turn curve, under a condition in which real-time lane recognition is difficult, the control device 100 may refer to the past lane information 11 configured based on the past travel trajectory of a lead vehicle 20. With this information, the control device 100 may set the current region of interest 12.

When a lane loss section is present (S310: YES) and past driving lane information is not present (S330: NO), the control device 100 may set the region of interest based on the current position and the heading value of the autonomous vehicle 10 (S350).

The control device 100 may receive the real-time position and the traveling direction (heading value) of the autonomous vehicle 10 through the sensor unit 150 or the communication unit 110 and set a space located in front of the vehicle and having a predetermined (e.g., threshold) distance and a predetermined (e.g., threshold) width as the region of interest based on this information.

The control device 100 may set the current vehicle position as a reference point and assume a straight or curved trajectory extending by a certain distance (e.g., 20 m) in the heading direction. The control device 100 may set the lateral width of the region of interest to be a standard lane width of the road (e.g., 3.4 m) or a user-defined value. The region of interest may be configured in the form of a rectangle or polygon with left-right symmetry around the vehicle traveling direction 13, and only objects in this region may be searched for as lead vehicle candidates.

FIG. 5 shows a diagram illustrating an example of the method of setting a region of interest.

As shown in FIG. 5, the autonomous vehicle 10 is traveling in a lane loss section, and the control device 100 may calculate the vehicle traveling direction 13 based on the current position of the vehicle and the heading value. In addition, a space corresponding to the road width d may be set as a region of interest with reference to the traveling direction. The region of interest in FIG. 5 may be configured to set a spatial reference to enable a lead vehicle search even in an initial entry section, a temporary road, a lane wear area, or the like in which none of a lane and a travel history is secured.

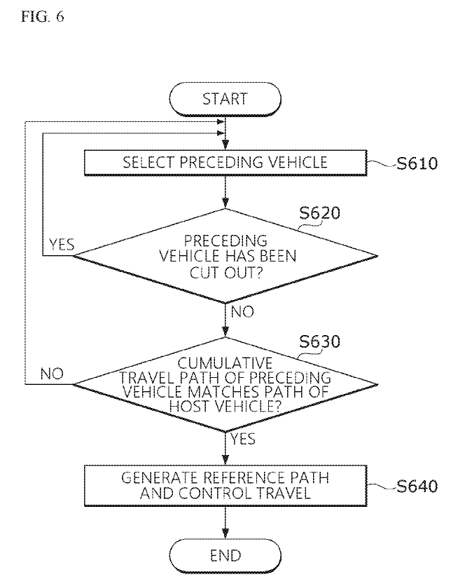

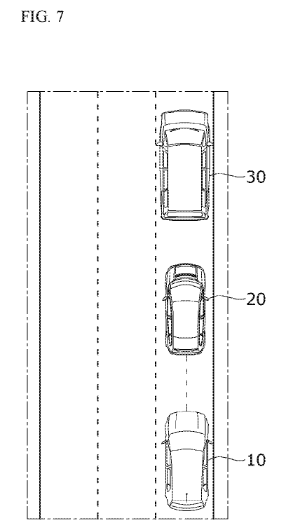

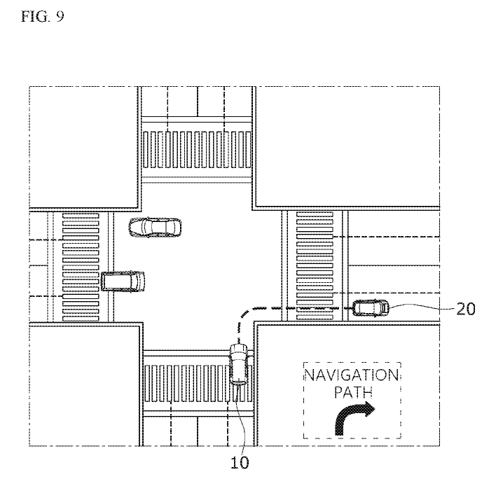

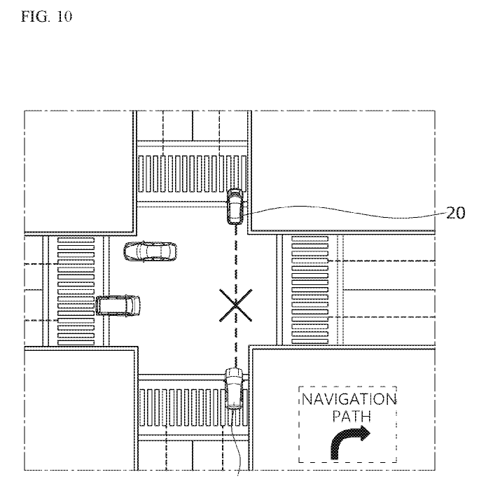

FIG. 6 shows a flowchart illustrating an example method of generating a reference path. FIG. 6 will be described with reference to FIGS. 7-10. FIGS. 7-9 show example diagrams of a lead vehicle that has cut out, and FIGS. 9 and 10 show example diagrams comparing a cumulative travel path of the lead vehicle with a reference path of the autonomous vehicle. The content of FIG. 6 that overlaps with FIGS. 2 or 3 may be omitted.

The control device 100 may select an object that satisfies a preset condition in the region of interest as a preceding vehicle (e.g., lead vehicle) (S610).

Specifically, the control device 100 may determine a vehicle that satisfies a certain criterion among candidate objects as a lead vehicle, based on the region-of-interest setting information stored in the storage unit 120 and the object recognition information obtained through the sensor unit 150.

The control device 100 may determine a lead vehicle based on the straight-line distance, the cumulative travel path, the heading value, the lateral position with reference to the reference path, and the like.

The control device 100 may determine a closest object on the linear distance based on the traveling direction of the autonomous vehicle 10 as a candidate of a lead vehicle.

The control device 100 may determine that an object is a valid lead vehicle only when the object has a travel path accumulated over a certain distance. For example, the control device 100 may use as a lead vehicle for generating a reference path only if at least a certain amount of travel path of the object (e.g., the lead vehicle) can be ascertained (e.g., obtained), such as when the travel path (e.g., cumulative travel path) is continuously monitored (e.g., collected) for at least a threshold distance (e.g., 5 m).

In addition, the control device 100 may compare the heading value of the lead vehicle with the heading value of an autonomous vehicle 10 as a reference and determine that the preset condition is satisfied when the difference is within a preset predetermined (e.g., threshold) angle (e.g., 45 degrees).

When the current lateral position of a lead vehicle is within a predetermined (e.g., threshold) distance (e.g., 1.7 m) from the reference path of the autonomous vehicle 10, the control device 100 may select the object as the lead vehicle.

When the above-described conditions are not satisfied, the control device 100 may not use the object as a reference for the reference path formation.

The control device 100 may determine whether the selected preceding vehicle (e.g., lead vehicle) has cut out (e.g., left or exited a lane, switched lanes, made a turn, etc.) (S620).

The control device 100 may compare the current position of the lead vehicle with a reference path or a centerline of travel of the autonomous vehicle 10, and the determination can be based on whether the lateral position deviation is greater than or equal to a predetermined (e.g., threshold) distance and whether that state is maintained for a time greater than or equal to a predetermined (e.g., threshold) time.

For example, when the state in which the lead vehicle deviates from the reference path of the autonomous vehicle 10 by 1.7 m or more lasts for 1 second or more, the control device 100 may determine that the vehicle has changed lane or deviated from the following criterion.

FIG. 7 shows an example diagram illustrating a state in which the lead vehicle is normally traveling on the reference path and has not cut out (e.g., left or exited a lane). The autonomous vehicle 10 may determine that the traveling trajectory of the lead vehicle 20 matches the reference path and may continue to follow the vehicle.

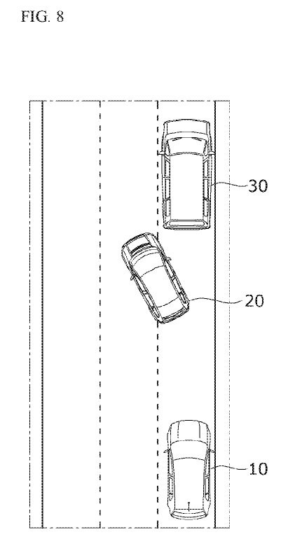

On the other hand, FIG. 8 shows an example diagram illustrating a state in which the lead vehicle 20 deviates from the lane in the lateral direction. If the lead vehicle 20 deviates from the reference path by a distance greater than or equal to a predetermined (e.g., threshold) distance as shown in FIG. 8, the control device 100 may determine that the lead vehicle has cut out. In this case, the control device 100 may select a new lead vehicle in order to stop following the lead vehicle 20 (e.g., terminate an autonomous driving operation of following the lead vehicle 20) and generate a reference path again. For example, the control device 100 may select a new vehicle 30 that satisfies a preset condition as a new lead vehicle.

This determination of cut-out may be performed to check whether the lead vehicle has substantially deviated from the reference path or travel path of the current autonomous vehicle 10.

The control device 100 may determine whether the cumulative travel path of the selected lead vehicle matches the navigation path of the autonomous vehicle 10 (S630).

The control device 100 may confirm the cumulative travel path data of the lead vehicle 20 stored in the storage unit 120 and determine whether the lead vehicle 20 matches the rotation information and the global path of the autonomous vehicle 10.

FIG. 9 shows a case where the two paths coincide. The autonomous vehicle 10 needs to make a right turn according to the navigation path, and the lead vehicle 20 is also making a right turn in the same manner. In this case, the control device 100 may determine that the cumulative travel path of the lead vehicle coincides with the global path of the autonomous vehicle.

On the other hand, FIG. 10 illustrates a situation in which the lead vehicle 20 is traveling straight, and so the travel path of the lead vehicle does not coincide with the right-turn path of the autonomous vehicle 10. In this case, the control device 100 may determine that the path of the lead vehicle does not satisfy the condition for generating a reference path. Therefore, the control device 100 may stop the path generation with reference to the lead vehicle 20 and select a new lead vehicle.

When it is determined that the path of the lead vehicle coincides with the path of the autonomous driving vehicle, the control device 100 may continue to generate a reference path based on the cumulative travel path of the preceding vehicle (e.g., lead vehicle) (S640).

The control device 100 may control travel of the autonomous vehicle 10 along the generated reference path, calculate a trajectory without a risk of collision together with surrounding object information collected from the sensor unit 150, and control longitudinal and lateral travel through the driving unit 160.

Since the reference path is based on a trajectory in which the lead vehicle 20 actually travels, the reference path may be utilized as a substantially travelable path even in a section in which road shape or lane information is lost.

The control device 100 may perform lane departure prevention, trajectory following, steering control, and the like based on the reference path.

In addition, since the path is generated based on the cumulative path in which the lead vehicle travels while avoiding a surrounding object in the actual road situation, the control device 100 may obtain the reference path in which the surrounding object avoidance result is indirectly reflected in the path, even when the obstacle avoidance operation is not explicitly performed. Therefore, the control device 100 can ensure a reliable reference path and ensure travel safety. The cumulative path of the lead vehicle may be, for example, a trajectory, a historical path, a motion history, or a monitored path.

The control device 100 may output a control state or a determination result of the autonomous vehicle 10 through the input/output interface 140.

Specifically, the control device 100 may be configured to output at least one of result of setting the region of interest, information of a selected lead vehicle, and a generated reference path to the user or the system.

For example, the control device 100 may visually output the shape or the search range of the region of interest set in the lane loss section or may provide the driver or the system operator with information such as the presence, the position, the direction, and the like of the lead vehicle currently following.

In addition, the control device 100 may output the generated reference path in a visual or voice form so that the driver may recognize the path the autonomous vehicle is traveling along. In this way, the interface efficiency between the driver and the system can be increased, and the determination or control result can be linked with an external system.

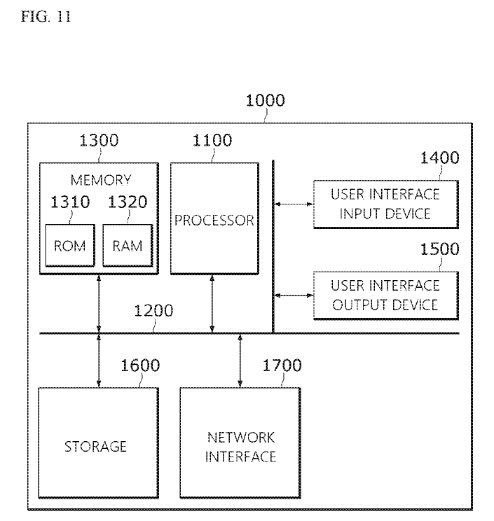

FIG. 11 shows an example computing system (e.g., a computing device of a vehicle or any other apparatus). One or more controllers, processors, etc. described herein (e.g., the autonomous vehicle 10, the control device 100, the communication unit 110, the storage unit 120, the processor 130, the input and output interface 140, the sensor unit 150, the driving unit 160, etc.) may be implemented by the computing system or may be implemented in the computing system.

A computing system (also referred to as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable read-only memory (EPROM), an electrically erasable and programmable read-only memory (EEPROM), a register, a hard disk drive, a removable disc, or a compact disc read-only memory (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An autonomous vehicle control device according to the present disclosure may comprise: a memory; and one or more processors electrically or adaptively coupled to the memory, wherein the one or more processors may be configured to: determine whether a lane unrecognized section is detected in a section in which the autonomous vehicle is scheduled to travel; set a region of interest, when a lane unrecognized section is detected, according to presence or absence of past travel lane information of the lane unrecognized section; select a preceding vehicle that satisfies a preset condition based on an object recognition result in the region of interest; generate a reference path of the autonomous vehicle, when a cumulative travel path of the preceding vehicle matches a path according to navigation information of the autonomous vehicle, based on the cumulative travel path of the preceding vehicle; and control travel of the autonomous vehicle based on the generated reference path.

The one or more processors may be further configured to set a region of interest for selecting a preceding vehicle based on a current position and a heading value of the autonomous vehicle, when the past travel lane information of the lane unrecognized section is not present.

The one or more processors may be further configured to select a closest vehicle based on a traveling direction of the autonomous vehicle as the preceding vehicle.

The one or more processors may determine that the preset condition is satisfied, when the cumulative travel path of the preceding vehicle is greater than or equal to a preset distance.

The one or more processors may determine that the preset condition is satisfied, when a heading value of the preceding vehicle is within a predetermined angle with reference to a heading value of the autonomous vehicle.

The one or more processors may determine that the preset condition is satisfied, when a lateral position of the preceding vehicle is within a predetermined distance from the reference path.

The one or more processors may be further configured to determine that the preceding vehicle has been cut out and reselect a preceding vehicle, when the preceding vehicle remains deviated from the reference path by a distance greater than or equal to a predetermined distance for a time greater than or equal to a predetermined time.

The one or more processors may be further configured to maintain following of the preceding vehicle only when the cumulative travel path of the preceding vehicle matches a path according to the navigation information of the autonomous vehicle.

The one or more processors may be further configured to output at least one of a result of setting the region of interest, information of a selected preceding vehicle, and a generated reference path through an input/output interface of the autonomous vehicle.

The one or more processors may be further configured to set a region of interest for selecting a preceding vehicle based on lane recognition information of the autonomous vehicle, when the lane unrecognized section is not detected.

A method of controlling an autonomous vehicle according to the present disclosure may comprise: determining whether a lane unrecognized section is detected in a section in which the autonomous vehicle is scheduled to travel; setting a region of interest, when a lane unrecognized section is detected, according to presence or absence of past travel lane information of the lane unrecognized section; selecting a preceding vehicle that satisfies a preset condition based on an object recognition result in the region of interest; generating a reference path of the autonomous vehicle, when a cumulative travel path of the preceding vehicle matches a path according to navigation information of the autonomous vehicle, based on the cumulative travel path of the preceding vehicle; and controlling travel of the autonomous vehicle based on the generated reference path.

When the past travel lane information of the lane unrecognized section is not present, a region of interest for selecting a preceding vehicle is set based on a current position and a heading value of the autonomous vehicle.

A closest vehicle based on a traveling direction of the autonomous vehicle is selected as the preceding vehicle.

When the cumulative travel path of the preceding vehicle is greater than or equal to a preset distance, the preset condition is determined to be satisfied.

When a heading value of the preceding vehicle is within a predetermined angle with reference to a heading value of the autonomous vehicle, the preset condition is determined to be satisfied.

When a lateral position of the preceding vehicle is within a predetermined distance from the reference path, the preset condition is determined to be satisfied.

When the preceding vehicle remains deviated from the reference path by a distance greater than or equal to a predetermined distance for a time greater than or equal to a predetermined time, the preceding vehicle is determined to have been cut out, and a preceding vehicle is reselected.

Following of the preceding vehicle is maintained only when the cumulative travel path of the preceding vehicle matches a path according to the navigation information of the autonomous vehicle.

At least one of a result of setting the region of interest, information of a selected preceding vehicle, and a generated reference path is output through an input/output interface of the autonomous vehicle.

When the lane unrecognized section is not detected, a region of interest for selecting a preceding vehicle is set based on lane recognition information of the autonomous vehicle.

According to the present disclosure, even when a lane unrecognized section is detected, a reference path is generated by using the preceding vehicle's cumulative travel path, the autonomous vehicle's navigation path, and object recognition information of a preceding vehicle, so that an autonomous vehicle can maintain driving control even in a road situation where an intersection or a lane is lost.

The effects of the present invention are not limited to the above-mentioned effects, and other effects that are not mentioned will be clearly understood by a person skilled in the art from the following description

The term '-unit' as used herein may refer to a hardware component, such as a Field-Programmable Gate Array (FPGA) or an Application-Specific Integrated Circuit (ASIC), or software, and the '-unit' performs certain roles. However, the '-unit' is not limited to software or hardware. A '-unit' may be configured to reside in an addressable storage medium and may be configured to be executed by one or more processors. Therefore, as an example, a '-unit' includes components such as software components, object-oriented software components, class components, and task components, as well as processes, functions, attributes, procedures, subroutines, segments of program code, drivers, firmware, microcode, circuitry, data, databases, data structures, tables, arrays, and variables. The functionality provided in the components and '-units' may be combined into a smaller number of components and '-units' or further separated into additional components and '-units'. Furthermore, the components and '-units' may be implemented to be executed by one or more CPUs within a device or a secure multimedia card.

While the present disclosure has been described with reference to one or more example embodiments, it will be understood by those skilled in the art that various modifications and changes may be made to the present disclosure without departing from the spirit and scope of the disclosure as set forth in the claims that follow.

What is claimed is:

1. An apparatus for an autonomous vehicle, the apparatus comprising:
a processor; and
a memory storing at least one instruction that is configured to be executed by the processor to cause the apparatus to:
determine whether at least one road segment, in which a lane marking is missing for at least a threshold distance, is detected in a planned travel route of the autonomous vehicle;
set, based on detecting the at least one road segment and based on whether historical traffic lane information comprises lane information of the at least one road segment, a region of interest;
select, among one or more objects recognized in the region of interest, a lead vehicle that satisfies a predetermined condition;
based on a monitored path of the lead vehicle matching the planned travel route of the autonomous vehicle, set the monitored path of the lead vehicle as a reference path of the autonomous vehicle; and
control, based on the reference path, an autonomous driving operation of the autonomous vehicle.

2. The apparatus of claim 1, wherein the at least one instruction is configured to be executed by the processor to cause the apparatus to set the region of interest by:
based on the historical traffic lane information not comprising the lane information of the at least one road segment, setting the region of interest based on a position of the autonomous vehicle and a heading of the autonomous vehicle.

3. The apparatus of claim 1, wherein the lead vehicle is a vehicle closest to the autonomous vehicle, among vehicles recognized in the region of interest, and is traveling in a same direction as the autonomous vehicle.

4. The apparatus of claim 1, wherein the predetermined condition comprises the monitored path of the lead vehicle being greater than or equal to a predetermined distance.

5. The apparatus of claim 1, wherein the predetermined condition comprises a heading of the lead vehicle being within a predetermined angle with reference to a heading of the autonomous vehicle.

6. The apparatus of claim 1, wherein the predetermined condition comprises a lateral position of the lead vehicle being within a predetermined distance from the reference path.

7. The apparatus of claim 1, wherein the at least one instruction is configured to be executed by the processor to further cause the apparatus to:
based on the lead vehicle deviating from the reference path by at least a predetermined distance for at least a predetermined time duration, select a new lead vehicle to follow.

8. The apparatus of claim 1, wherein the at least one instruction is configured to be executed by the processor to further cause the apparatus to:
control the autonomous vehicle to continue to follow the lead vehicle based on an updated monitored path of the lead vehicle matching the planned travel route of the autonomous vehicle.

9. The apparatus of claim 1, wherein the at least one instruction is configured to be executed by the processor to further cause the apparatus to:
output, via a user interface of the autonomous vehicle, an indication of at least one of: the region of interest, the lead vehicle, or the reference path.

10. A method performed by an apparatus of an autonomous vehicle, the method comprising:
determining whether at least one road segment, in which a lane marking is missing for at least a threshold distance, is detected in a planned travel route of the autonomous vehicle;
setting, based on detecting the at least one road segment and based on whether historical traffic lane information comprises lane information of the at least one road segment, a region of interest;
selecting, among one or more objects recognized in the region of interest, a lead vehicle that satisfies a predetermined condition;
based on a monitored path of the lead vehicle matching the planned travel route of the autonomous vehicle, setting the monitored path of the lead vehicle as a reference path of the autonomous vehicle; and
controlling, based on the reference path, an autonomous driving operation of the autonomous vehicle.

11. The method of claim 10, wherein the setting of the region of interest comprises:
based on the historical traffic lane information not comprising the lane information of the at least one road segment, setting the region of interest based on a position of the autonomous vehicle and a heading of the autonomous vehicle.

12. The method of claim 10, wherein the lead vehicle is a vehicle closest to the autonomous vehicle, among vehicles recognized in the region of interest, and is traveling in a same direction as the autonomous vehicle.

13. The method of claim 10, wherein the predetermined condition comprises the monitored path of the lead vehicle being greater than or equal to a predetermined distance.

14. The method of claim 10, wherein the predetermined condition comprises a heading of the lead vehicle being within a predetermined angle with reference to a heading of the autonomous vehicle.

15. The method of claim 10, wherein the predetermined condition comprises a lateral position of the lead vehicle being within a predetermined distance from the reference path.

16. The method of claim 10, further comprising:
based on the lead vehicle deviating from the reference path by at least a predetermined distance for at least a predetermined time duration, selecting a new lead vehicle to follow.

17. The method of claim 10, further comprising:
controlling the autonomous vehicle to continue to follow the lead vehicle based on an updated monitored path of the lead vehicle matching the planned travel route of the autonomous vehicle.

18. The method of claim 10, further comprising:
outputting, via a user interface of the autonomous vehicle, an indication of at least one of: the region of interest, the lead vehicle, or the reference path.

19. An autonomous vehicle comprising:
at least one sensor;
a processor; and
a memory storing at least one instruction that is configured to be executed by the processor to cause the autonomous vehicle to:
during a driving operation of the autonomous vehicle, generate, via the at least one sensor, an image of an unmarked road segment, wherein a lane marking is missing in the image of the unmarked road segment;
monitor a driving path of at least one target vehicle in the unmarked road segment;
generate, based on the monitored driving path of the at least one target vehicle matching a planned travel route of the autonomous vehicle, a reference path; and
output, based on the reference path, a signal for a driving operation of the autonomous vehicle.

20. The autonomous vehicle of claim 19, wherein the at least one target vehicle comprises a lead vehicle and at least one candidate lead vehicle, and
wherein the at least one instruction is configured to be executed by the processor to further cause the autonomous vehicle to:
determine, based on the monitored driving path of the at least one target vehicle, the reference path for the autonomous vehicle to drive along during an autonomous driving operation of the autonomous vehicle;
select, based on the lead vehicle deviating from the reference path by at least a threshold distance, a new lead vehicle among the at least one candidate lead vehicle; and
continue, based on the monitored driving path of the new lead vehicle matching the planned travel route of the autonomous vehicle, the autonomous driving operation of the autonomous vehicle by following the new lead vehicle.
